(19) United States
(12) Patent Application Publication
(10) Pub. No.: US 2014/0175761 A1
(43) Pub. Date: Jun. 26, 2014

(54) SLEEVE FOR HEATING A TOOLHOLDER

(71) Applicant: Chin-Chiu CHEN, Taichung City (TW)

(72) Inventor: Chin-Chiu CHEN, Taichung City (TW)

(21) Appl. No.: 13/724,965

(22) Filed: Dec. 21, 2012

(51) Int. Cl. B23B 31/24

(52) U.S. Cl. CPC B23B 31/24
USPC 279/9.1

(57) ABSTRACT

A sleeve for heating a toolholder is magnetizable and has a sleeved space, at least one slit, and an abutting surface. The sleeved space is formed along an axial direction of the sleeve. The at least one slit is formed on the sleeve. The abutting surface is formed inside the sleeve. The sleeve is mounted around a toolholder by the sleeved space, and the abutting surface abuts the cutting tool. The sleeve can be heated by electromagnetic force, especially for steel material containing high chromium, and heats the toolholder by heat conduction. As a result, the toolholder can be heated easily by the sleeve, and can be mounted tightly and firmly around a cutting tool.

### BACKGROUND OF THE INVENTION

1. Field of the Invention

The present invention relates to a sleeve, and more particularly to a sleeve for heating a toolholder.

2. Description of Related Art

A cutting tool operated at high speed, such as a milling cutter, has an end inserted into a toolholder to be assembled with a machine and used for cutting or grinding an object.

With reference to FIG. 7, a conventional heating device for a toolholder comprises an induction coil base 60 mounted around a toolholder 70 and having an inside wall spaced from the toolholder 70. The toolholder 70 is made of metal, especially steel containing high amount of chromium, for example, over 13% of chromium.

The induction coil base 60 is powered to heat the toolholder 70 by electromagnetic force. A shielding-ring 90 is mounted on an end of the toolholder 70 to gather the magnetic flux along the axial direction of the toolholder 70. A cutting tool 80 is inserted into the toolholder 70 when the toolholder 70 is thermally expanded, and then the induction coil base 60 is removed to let the toolholder 70 be thermally contracted. Thus, the toolholder 70 is combined securely with the cutting tool 80.

However, the toolholder 70 cannot be electromagnetically heated easily because the toolholder 70 is made of steel containing high amount of chromium. As a result, the toolholder 70 may not be mounted tightly and firmly around the cutting tool 80.

### SUMMARY OF THE INVENTION

The main object of the present invention is to provide an improved sleeve for heating a toolholder, and the sleeve for heating a toolholder is magnetizable and comprises a first end, a second end, an axial direction, a sleeved space formed along the axial direction, and an abutting surface formed inside the sleeve.

Preferably, the sleeve further has a slit formed in the sleeve, and the slit has a longitudinal direction being parallel with the axial direction of the sleeve, and a slit opening formed on the first end or the second end of the sleeve.

Preferably, the sleeve has eight slits, and each slit has a longitudinal direction being parallel with the axial direction of the sleeve; wherein the slits are arranged alternately, four of the slits have four slit openings respectively formed on the first end, and the other four slits have four slit openings respectively formed on the second end.

The sleeve is mounted tightly around a toolholder, and an electromagnetic heating cover is mounted around the sleeve to heat the sleeve by electromagnetic force, and then the sleeve heats the toolholder by heat conduction. The toolholder will be thermally expanded and a cutting tool will be mounted into the toolholder. The sleeve and the electromagnetic heating cover are removed to let the toolholder be thermally contracted and be mounted firmly around the cutting tool.

### BRIEF DESCRIPTION OF THE DRAWINGS

FIG. 1 is a perspective view of a first preferred embodiment of a sleeve for heating a toolholder in accordance with the present invention;

FIG. 2 is a perspective view in partial section of the sleeve in FIG. 1;

FIG. 3 is an operational side view in partial section of the sleeve in FIG. 1;

FIG. 4 is a perspective view of a second preferred embodiment of a sleeve for heating a toolholder in accordance with the present invention;

FIG. 5 is a perspective view in partial section of the sleeve in FIG. 4;

FIG. 6 is an operational side view in partial section of the sleeve in FIG. 4; and

FIG. 7 is an operational side view in partial section of a conventional heating device for a toolholder.

### DETAILED DESCRIPTION OF PREFERRED EMBODIMENT

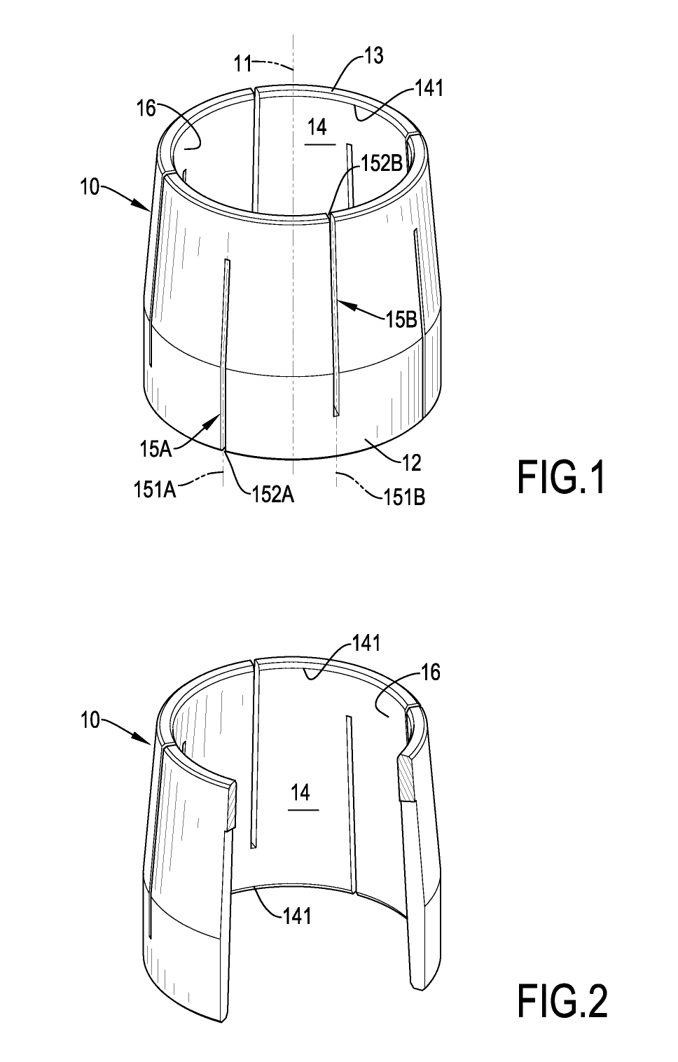

With reference to FIGS. 1 and 2, a preferred embodiment of a sleeve 10 for heating a toolholder in accordance with the present invention is made of magnetizable metal, and comprises an axial direction 11, a first end 12, a second end 13, a sleeved space 14, four first slits 15A, four second slits 15B, and an abutting surface 16. The sleeved space 14 is formed along the axial direction 11 of the sleeve 10 and has two sleeve openings 141 formed respectively at the first end 12 and the second end 13 of the sleeve 10. The first slits 15A and the second slits 15B are formed in the sleeve 10. Each first slit 15A has a first longitudinal direction 151A, and each second slit 15B has a second longitudinal direction 151B. The first longitudinal directions 151A and the second longitudinal directions 151B are parallel with the axial direction 11 of the sleeve 10. The first slits 15A and the second slits 15B are arranged alternately. Each first slit 15A comprises a first slit opening 152A formed at the first end 12, and each second slit 15B comprises a second slit opening 152B formed at the second end 13. The abutting surface 16 is formed inside the sleeve 10.

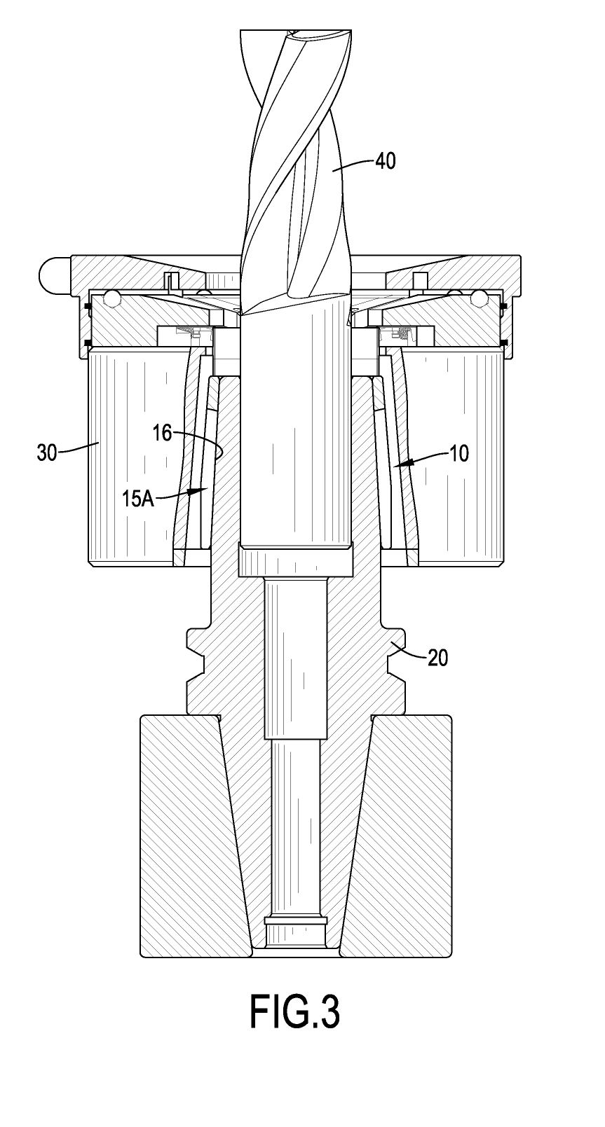

With reference to FIG. 1 and FIG. 3, the sleeve 10 is mounted around a toolholder 20 by the sleeved space 14, and the abutting surface 16 abuts the toolholder 20. An electromagnetic heating cover 30 is mounted around the sleeve 10 and heats the sleeve 10 by electromagnetic force. The sleeve 10 is heated and transfers the calorific capacity to the toolholder 20 by heat conduction. The toolholder 20 is heated and is thermally expanded, and then a cutting tool 40 can be inserted into the toolholder 20. The sleeve 10 and the electromagnetic heating cover 30 will be removed after the cutting tool 40 is inserted into the toolholder 20. The first slits 15A and the second slits 15B make the sleeve 10 expandable in a radial direction. Therefore, the sleeve 10 can easily depart from the toolholder 20. The toolholder 20 will cool down and abut the cutting tool 40 tightly. As a result, the cutting tool 40 is assembled firmly in the toolholder 20.

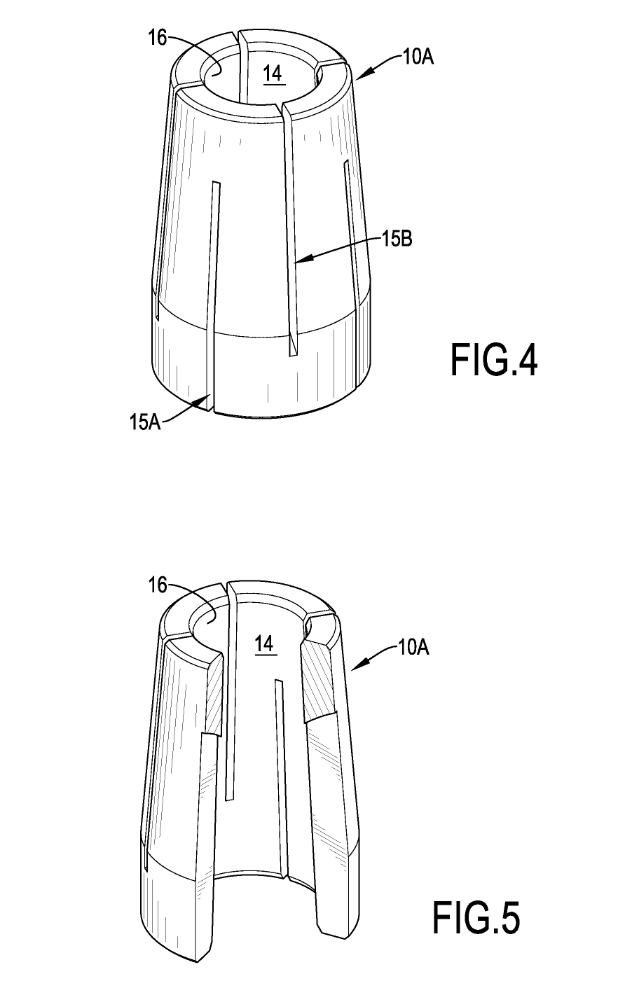

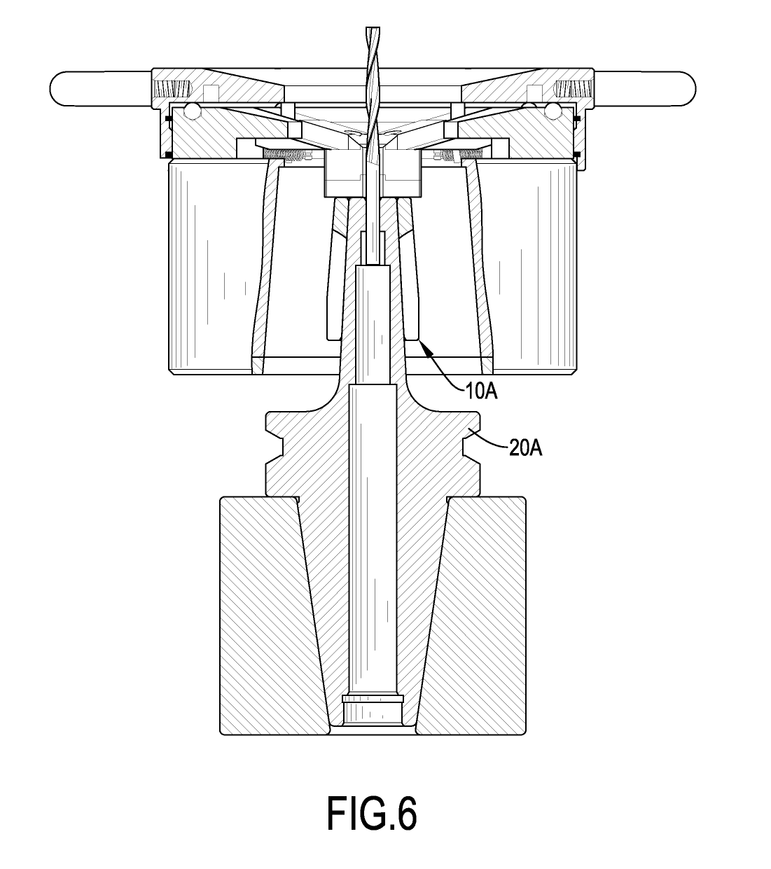

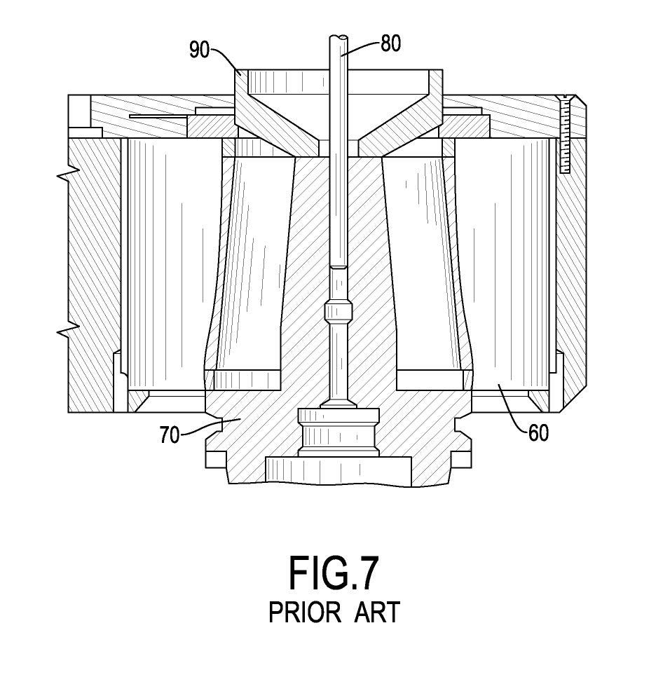

With reference to FIGS. 4 and 5, a diameter of the sleeve 10A of a second preferred embodiment is smaller than a diameter of the sleeve 10 of the first preferred embodiment, and the sleeve 10A is used to fit over a toolholder having a smaller diameter. With reference to FIG. 6, the sleeve 10A is mounted around and abuts a toolholder 20A. The sleeve 10A can be heated by electromagnetic force and the calorific capacity of the sleeve 10A will be transferred to the toolholder 20A by heat conduction, especially for toolholder 20A made of steel material containing high chromium. Accordingly, the sleeve will heat the toolholder 20A efficiently.

What is claimed is:

1. A sleeve for heating a toolholder being magnetizable and comprising:
a first end;
a second end;
an axial direction;
a sleeved space formed along the axial direction; and
an abutting surface formed inside the sleeve.

2. The sleeve as claimed in claim 1, wherein the sleeve further has a slit formed in the sleeve, and the slit has
a longitudinal direction being parallel with the axial direction of the sleeve; and
a slit opening formed on the first end or the second end of the sleeve.

3. The sleeve as claimed in claim 1, wherein the sleeve has eight slits, and each slit has a longitudinal direction being parallel with the axial direction of the sleeve; wherein the slits are arranged alternately, four of the slits each having a slit opening are respectively formed in the first end, and the other four slits each having a slit opening are respectively formed in the second end.
